(19) United States
(12) Patent Application Publication
(10) Pub. No.: US 2008/0094314 A1
(43) Pub. Date: Apr. 24, 2008

(54) Display Unit

(75) Inventors: Edzer Huitema, Eindhoven (NL); Karel Elbert Kuijk, Dommelen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/575,140

(22) PCT Filed: Sep. 13, 2005
(86) PCT No.: PCT/IB05/53003

§ 371 Date: Mar. 13, 2007

(30) Foreign Application Priority Data
Sep. 17, 2004 (EP) 04104519.6

(51) Int. Cl. G09G 3/20

(52) U.S. Cl. 345/55

(57) ABSTRACT

Display units (1) comprising display panels (50) with pixels (11) coupled to storage lines (62,63) via storage capacitors (13) are provided with storage line drivers (60,70) for driving the storage lines (62,63) for reducing necessary electrode voltage swings on electrodes such as row electrodes (41,42,43,44,45,49) and column electrodes (31,32,34,35,39). A storage line pulse is to be generated during at least a part of a row activation pulse, then the row activation pulse or a row de-activation pulse may get a reduced value such that the necessary electrode voltage swing is reduced. Alternatively, alternating storage line pulses having a period of at most a duration of a row activation pulse are to be generated, then a data pulse may get a reduced value such that the necessary electrode voltage swing is reduced. This all results in more stable drivers, a smaller display unit, a lower overall power consumption and common available row drivers and less expensive column drivers.

The invention relates to a display unit, to a display device comprising a display unit, to a method for driving a display unit and to a processor program product for driving a display unit.

Examples of display devices of this type are: monitors, laptop computers, personal digital assistants (PDAs), mobile telephones and electronic books, electronic newspapers, and electronic magazines.

A prior art display unit is known from Unites States Patent Application Publication US 2003/0043138 A1. This patent application discloses an electrophoretic display unit comprising a display panel with pixels arranged in rows and columns. Each pixel is coupled to a storage capacitor. The display panel further comprises a storage line per row. The storage capacitors coupled to the pixels in a row are all coupled to the same storage line. Each pixel is further coupled to a common electrode or counter electrode and is coupled via a pixel electrode to the drain of a transistor, of which the source is coupled to a column electrode or data electrode and of which the gate is coupled to a row electrode or selection electrode. This arrangement of pixels, transistors and row and column electrodes jointly forms an active matrix. A row driver or a select driver supplies a row driving signal or a selection signal for selecting a row of pixels and a column driver or a data driver supplies column driving signals or data signals to the selected row of pixels via the column electrodes and the transistors.

Each pixel for example corresponds with a microcapsule comprising charged particles. In dependence of a positive or negative voltage applied to the pixel electrode, the particles move, and the pixel becomes white/colored or appears dark to a viewer. When the electric voltage is removed, the display unit remains in the acquired state and exhibits a bi-stable character.

The known display unit is disadvantageous, inter alia, owing to the fact that the electrodes require voltage swings which are relatively high. As a result, the electrode drivers cannot be common available drivers, but must be designed and produced for such an exceptional environment. This makes the drivers more expensive. Further, a relatively high voltage swing results in the power consumption of the display unit being relatively high.

It is an object of the invention, inter alia, to provide a display unit, in which at least one electrode has a reduced voltage swing.

Further objects of the invention are, inter alia, to provide a display device comprising a display unit, a method for driving a display unit and a processor program product for driving a display unit, in which display unit at least one electrode has a reduced voltage swing.

A display unit according to the invention comprises

a display panel with a pixel coupled to a storage line via a storage capacitor; and

a storage line driver for driving the storage line for reducing a necessary electrode voltage swing.

A storage line driver for driving the storage line is common in the art. However, this prior art driving of the storage line is done to supply additional voltages to the pixel for creating an additional pixel effect. According to the invention, the driving of the storage line is done for reducing the necessary (minimal) electrode voltage swing. Thereto, for a column electrode, the storage line is driven in such a way that the column driver can use a reduced voltage swing to get the pixel to behave as before, at least in the eyes of a user. For a row electrode, the storage line is driven in such a way that the row driver can use a reduced voltage swing to get the transistor to behave as before. As a result, common available drivers can now be used, and the power consumption of the display unit is reduced.

It should be noted that Unites States Patent Application Publication US 2003/0043138 A1 discloses an introduction of correction means for modifying voltages generated by the drive circuit means to compensate for display artifacts, such as flicker. This has nothing to do with reducing a necessary electrode voltage swing.

An embodiment of a display unit according to the invention is defined by further comprising

an electrode driver for driving an electrode coupled to the pixel via a switching element, the electrode voltage swing being a voltage swing of this electrode.

This switching element may comprise the transistor discussed above, without excluding other switching elements.

An embodiment of a display unit according to the invention is defined by the electrode being a selection electrode and the selection electrode driver being arranged to generate an activation pulse for activating the selection electrode and the storage line driver being arranged to generate a storage line pulse during at least a part of the activation pulse. By supplying a storage line pulse during at least a part of the activation pulse via the storage capacitor and via the pixel to the switching element receiving the activation pulse, the selection electrode driver can use a reduced voltage swing to get the transistor to behave as before.

An embodiment of a display unit according to the invention is defined by the electrode driver being further arranged to generate a de-activation pulse for de-activating the selection electrode. In case of the activation pulse also being known as row selection pulse, the de-activation pulse may also be known as row non-selection pulse.

An embodiment of a display unit according to the invention is defined by the de-activation pulse having a reduced extreme value such that the necessary electrode voltage swing is reduced. In this case, the necessary voltage swing of the selection electrode is reduced by reducing an extreme value of the de-activation pulse.

An embodiment of a display unit according to the invention is defined by the activation pulse having a reduced extreme value such that the necessary voltage swing is reduced. In this case, the necessary voltage swing of the selection electrode is reduced by reducing an extreme value of the activation pulse.

An embodiment of a display unit according to the invention is defined by an end of the activation pulse preceding or corresponding with an end of the storage line pulse. To avoid the so-called kickback voltage, the end of the activation pulse should preferably not exceed the end of the storage line pulse.

An embodiment of a display unit according to the invention is defined by the selection electrode driver comprising a first stage for driving the electrode and a second stage constituting the storage line driver. In this efficient case, only one selection electrode driver with two output stages is used (for a predefined number of selection electrodes) for generating the activation pulse and the storage line pulse. Both these pulses may have large similarities.

An embodiment of a display unit according to the invention is defined by the electrode being a data electrode and the data electrode driver being arranged to generate a data pulse and the storage line driver being arranged to generate alternating pulses having a period of at most a duration of an activation pulse, the display unit further comprising

a selection electrode driver for generating the activation pulse for activating a selection electrode.

By supplying alternating pulses having a period of at most a duration of an activation pulse via the storage capacitor to the pixel, which pixel is loaded with data via a switching element receiving the activation pulse, the data electrode driver can use a reduced voltage swing to get the pixel to behave as before, at least in the eyes of a user.

An embodiment of a display unit according to the invention is defined by further comprising

a common electrode driver for driving a common electrode with the alternating pulses.

To support the storage line driver for supplying the alternating pulses via the storage capacitor to the pixel, a common electrode driver is used for supplying additional alternating pulses to the pixel via the common electrode.

An embodiment of a display unit according to the invention is defined by further comprising

the display panel with a further pixel coupled to a further storage line via a further storage capacitor, which further storage line is coupled to the storage line;

the storage line driver being arranged to drive both storage lines simultaneously. In this efficient case, one storage line driver is used for supplying the alternating pulses to all storage lines simultaneously.

An embodiment of a display unit according to the invention is defined by the data pulse having a reduced extreme value such that the necessary voltage swing is reduced. In this case, the necessary voltage swing of the data electrode is reduced by reducing an extreme value of the data pulse.

An embodiment of a display unit according to the invention is defined by further comprising a controller, which is adapted to provide shaking data pulses, one or more reset data pulses, and one or more driving data pulses to the pixels. The shaking data pulses reduce the dependency of the optical response of the electrophoretic display unit on the history of the pixels. The shaking data pulses comprise pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history of the pixels resulting in a long switching time to overcome this high dependency. The application of the shaking data pulses increases the momentum of the electrophoretic particles and thus reduces the dependency resulting in a shorter switching time. The reset data pulses precede the driving data pulses to further improve the optical response of the display unit, by defining a fixed starting point (fixed black or fixed white) for the driving data pulses. Alternatively, the reset data pulses precede the driving data pulses to further improve the optical response of the display unit, by defining a flexible starting point (black or white, to be selected in dependence of and closest to the gray value to be defined by the following driving data pulses) for the driving data pulses.

The display device according to the invention may be an electronic book, while the storage medium for storing information may be a memory stick, an integrated circuit, a memory like an optical or magnetic disc or other storage device for storing, for example, the content of a book to be displayed on the display unit.

Embodiments of the method according to the invention and of the processor program product according to the invention correspond with the embodiments of the display unit according to the invention.

The invention is based upon an insight, inter alia, that a storage line is coupled to an electrode via a storage capacitor, a pixel and a switching element, and is based upon a basic idea, inter alia, that a necessary electrode voltage swing on this electrode can be reduced by driving the storage line.

The invention solves the problem, inter alia, to provide a display unit, in which at least one electrode has a reduced voltage swing, and is advantageous, inter alia, in that the power consumption of the display unit is reduced. Further, even common available drivers might be used.

These and other aspects of the invention will be apparent from and elucidated with reference to the embodiments(s) described hereinafter.

In the drawings:

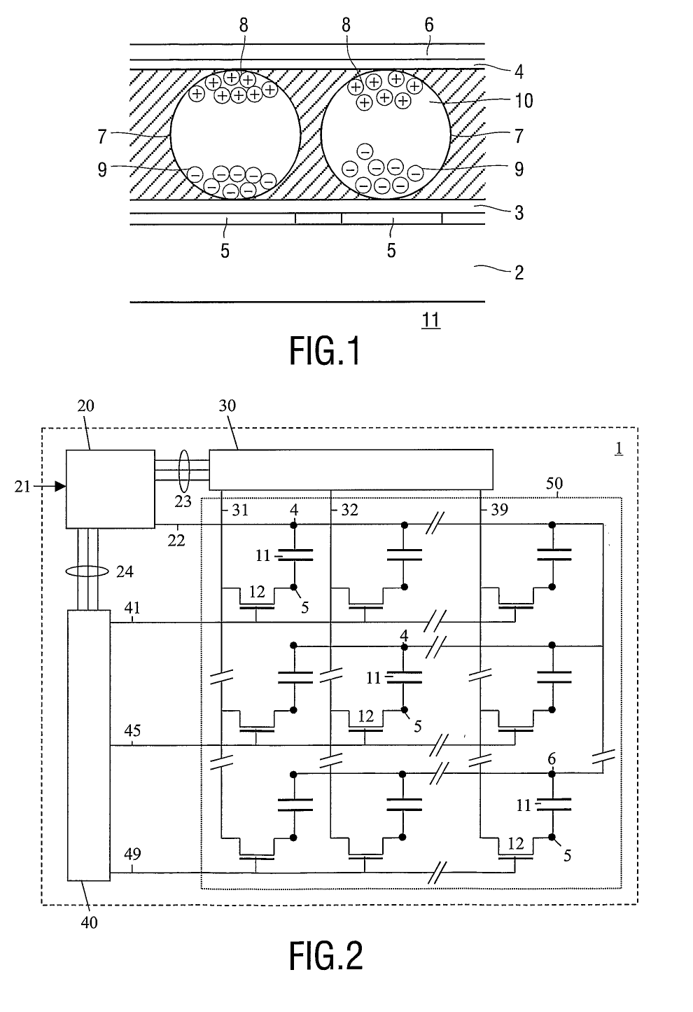

FIG. 1 shows (in cross-section) a bi-stable pixel;

FIG. 2 shows diagrammatically a display unit;

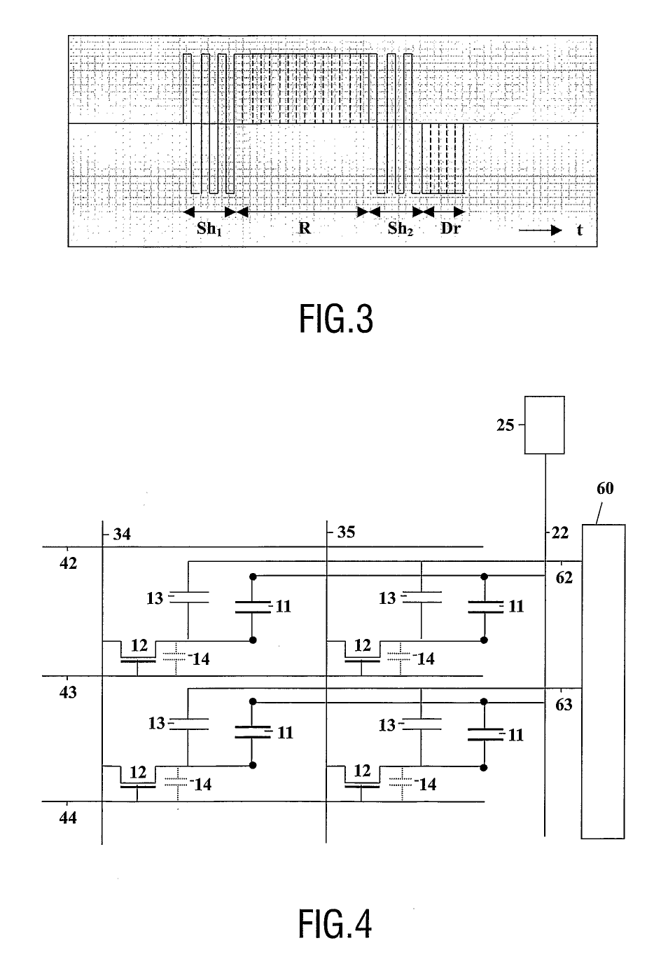

FIG. 3 shows a waveform for driving a display unit;

FIG. 4 shows diagrammatically a part of a display panel comprising storage capacitors, storage lines and a storage line driver;

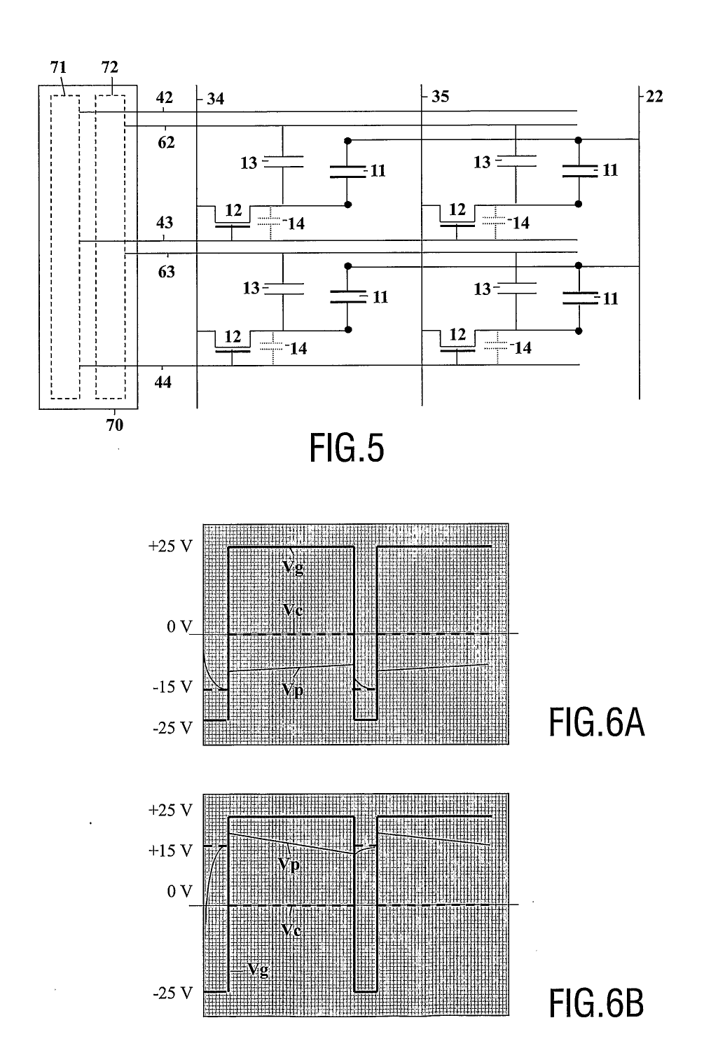

FIG. 5 shows diagrammatically a part of a display panel comprising storage capacitors, storage lines and a combined selection electrode+storage line driver;

FIG. 6 show a prior art row electrode signal Vg and a prior art column electrode signal Vc for a negative pixel electrode signal Vp (FIG. 6A) and for a positive pixel electrode signal Vp (FIG. 6B) in voltage (Volts) versus time (msec);

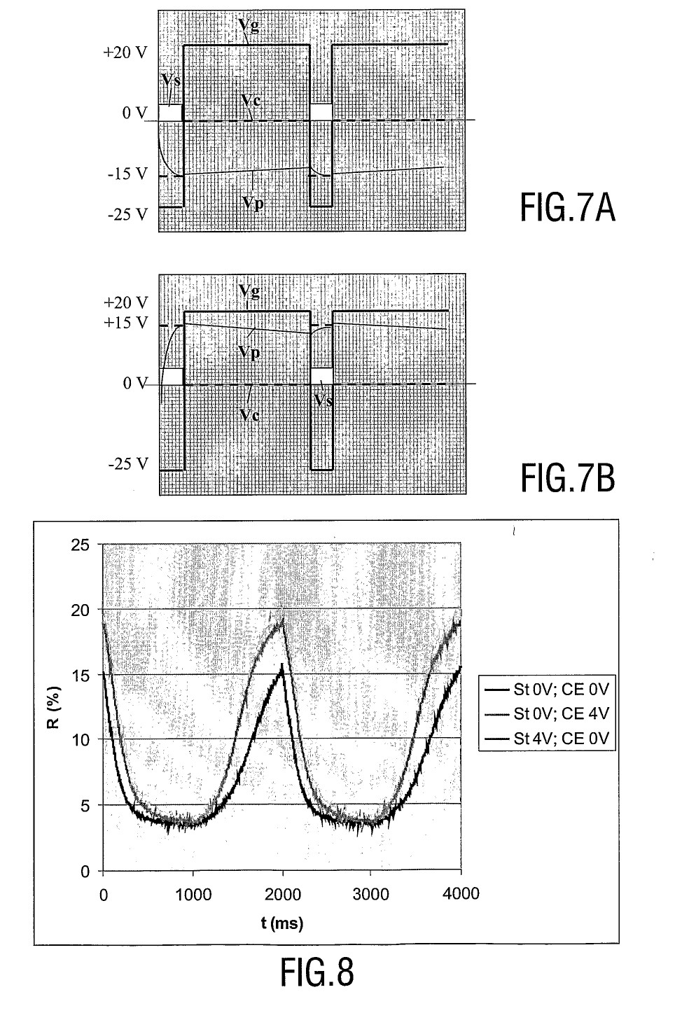

FIG. 7 show a row electrode signal Vg and a pixel electrode signal Vp for a negative column electrode signal Vc (FIG. 7A) and for a positive column electrode signal Vc (FIG. 7B) in voltage (Volts) versus time (msec) for a first storage line signal Vs according to the invention;

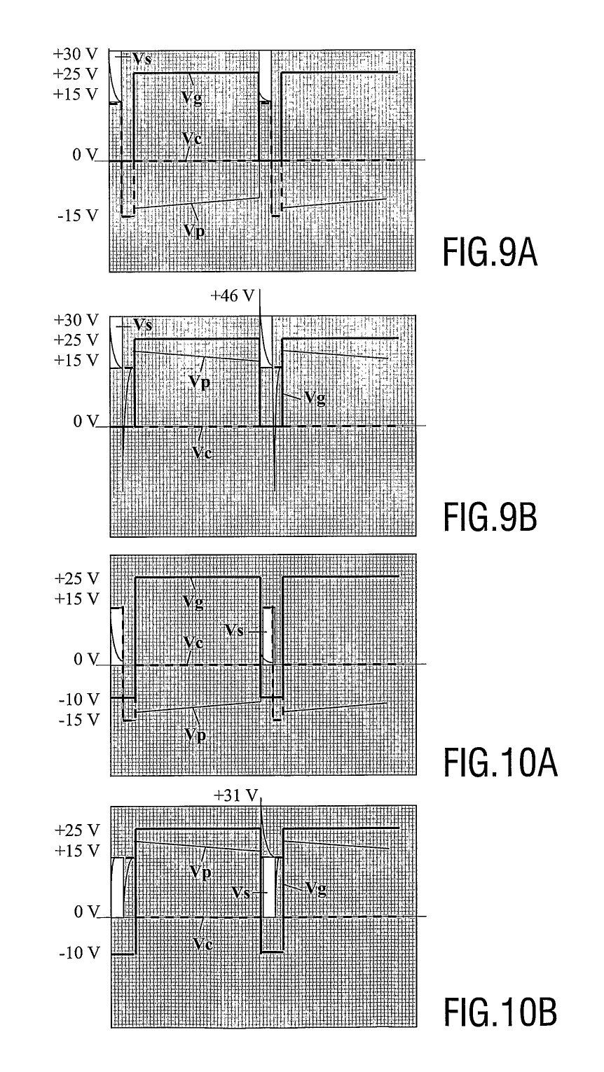

FIG. 8 shows a reflectivity (in %) versus time (msec) for a conventional driving scheme, for a common electrode driving scheme with a constant voltage and for a driving scheme in accordance with FIG. 7;

FIG. 9 show a row electrode signal Vg and a column electrode signal Vc for a negative pixel electrode signal Vp during a non-select period (FIG. 9A) and for a positive pixel electrode signal Vp during the non-select period (FIG. 9B) in voltage (Volts) versus time (msec) for a second storage line signal Vs according to the invention;

FIG. 10 show a row electrode signal Vg and column electrode signal Vc for a negative pixel electrode signal Vp during a non-select period (FIG. 10A) and for a positive pixel electrode signal Vp during the non-select period (FIG. 10B) in voltage (Volts) versus time (msec) for a third storage line signal Vs according to the invention;

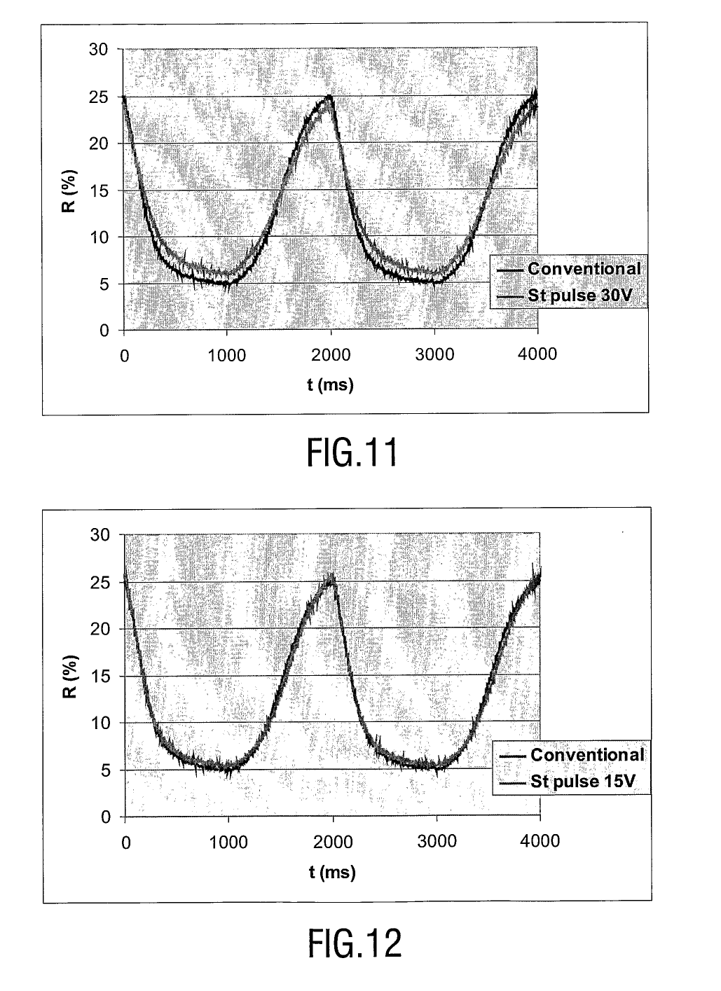

FIG. 11 shows a reflectivity (in %) versus time (msec) for a conventional driving scheme and for a driving scheme in accordance with FIG. 9;

FIG. 12 shows a reflectivity (in %) versus time (msec) for a conventional driving scheme and for a driving scheme in accordance with FIG. 10; and

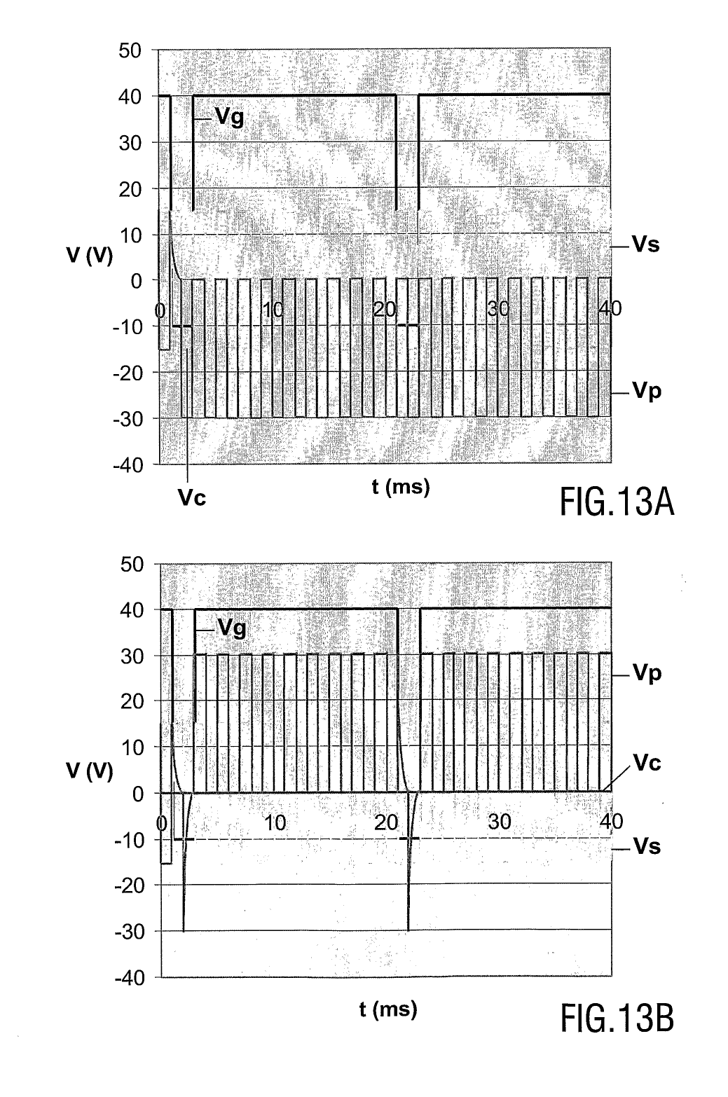

FIG. 13 show a row electrode signal Vg and column electrode signal Vc for a negative pixel electrode signal Vp during a non-select period (FIG. 13A) and for a positive pixel electrode signal Vp during the non-select period (FIG. 13B) in voltage (Volts) versus time (msec) for a fourth storage line signal Vs according to the invention.

The bi-stable pixel 11 of the display unit shown in FIG. 1 (in cross-section) comprises a bottom substrate 2 (like plastic or glass), an electrophoretic film (laminated on base substrate 2) with an electronic ink which is present between a glue layer 3 and a common electrode 4. The glue layer 3 is provided with transparent pixel electrodes 5. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 4, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 4, and the pixel appears dark to a viewer (not shown). When the electric voltage is removed, the particles 8,9 remain in the acquired state and the display exhibits a bi-stable character and consumes substantially no power. In alternative systems, particles may move in an in-plane direction, driven by electrodes which may be situated on the same substrate.

The (electrophoretic) display unit 1 shown in FIG. 2 comprises a display panel 50 comprising a matrix of pixels 11 at the area of crossings of line or row or selection electrodes 41,45,49 and column or data electrodes 31,32,39. These pixels 11 are all coupled to a common electrode 22, and each pixel 11 is coupled to its own pixel electrode 5. The display unit 1 further comprises selection driving circuitry 40 (line or row or selection driver) coupled to the row electrodes 41,45,49 and data driving circuitry 30 (column or data driver) coupled to the column electrodes 31,32,39 and comprises per pixel 11 an active switching element 12. The display unit 1 is driven by these active switching elements 12 (in this example (thin-film) transistors). The selection driving circuitry 40 consecutively selects the row electrodes 41,45,49, while the data driving circuitry 30 provides data signals to the column electrode 31,32,39. Preferably, a controller 20 first processes incoming data arriving via input 21 and then generates the data signals. Mutual synchronization between the data driving circuitry 30 and the selection driving circuitry 40 takes place via drive lines 23 and 24. Selection signals from the selection driving circuitry 40 select the pixel electrodes 5 via the transistors 12 of which the drain electrodes are electrically coupled to the pixel electrodes 5 and of which the gate electrodes are electrically coupled to the row electrodes 41,45,49 and of which the source electrodes are electrically coupled to the column electrodes 31,32,39. A data signal present at the column electrode 31,32,39 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to selection driving circuitry 40 via drive lines 24. These data signals comprise data-independent signals which are the same for all pixels 11 and data-dependent signals which may or may not vary per pixel 11. The data-independent signals comprise shaking data pulses, with the data-dependent signals comprising one or more reset data pulses and one or more driving data pulses. These shaking data pulses comprise pulses representing energy which is sufficient to release the (electrophoretic) particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels 11. So, the shaking data pulses reduce the dependency of the optical response of the display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the display unit, by defining a fixed starting point for the driving data pulse. This starting point may be a fixed black or fixed white level.

In FIG. 3, a waveform representing voltages across a pixel 11 as a function of time t is shown for driving an (electrophoretic) display unit 1. This waveform is generated using the data signals supplied via the data driving circuitry 30. The waveform comprises first shaking data pulses Sh₁, followed by one or more reset data pulses R, second shaking data pulses Sh₂ and one or more driving data pulses Dr. For example sixteen different waveforms are stored in a memory, for example a look-up table memory, forming part of and/or coupled to the controller 20. In response to data received via input 21, controller 20 selects a waveform for a pixel 11, and supplies the corresponding selection signals and data signals via the corresponding driving circuitry 30,40 and via the corresponding transistors 12 to the corresponding pixels 11.

A frame period corresponds with a time-interval used for driving all pixels 11 in the display unit 1 once (by driving each row one after the other and by driving all columns simultaneously once per row). For supplying data-dependent or data-independent signals to the pixels 11 during frames, the data driving circuitry 30 is controlled in such a way by the controller 20 that all pixels 11 in a row receive these data-dependent or data-independent signals simultaneously. This is done row by row, with the controller 20 controlling the selection driving circuitry 40 in such a way that the rows are selected one after the other (all transistors 12 in the selected row are brought into a conducting state).

During a first set of frames, the first and second shaking data pulses Sh₁ and Sh₂ are supplied to the pixels 11, with each shaking data pulse having a duration of one frame period. The starting shaking data pulse for example has a positive amplitude, the next one a negative amplitude, and the next one a positive amplitude etc. Therefore, these alternating shaking data pulses do not change the gray value displayed by the pixel 11, as long as the frame period is relatively short.

During a second set of frames comprising one or more frames periods, a combination of reset data pulses R is supplied, further to be discussed below. During a third set of frames comprising one or more frames periods, a combination of driving data pulses Dr is supplied, with the combination of driving data pulses Dr either having a duration of zero frame periods and in fact being a pulse having a zero amplitude or having a duration of one, two to for example fifteen frame periods. Thereby, a driving data pulse Dr having a duration of zero frame periods for example corresponds with the pixel 11 displaying full black (in case the pixel 11 already displayed full black; in case of displaying a certain gray value, this gray value remains unchanged when being driven with a driving data pulse having a duration of zero frame periods, in other words when being driven with a data pulse having a zero amplitude). The combination of driving data pulses Dr having a duration of fifteen frame periods comprises fifteen subsequent pulses and for example corresponds with the pixel 11 displaying full white, and the combination of driving data pulses Dr having a duration of one to fourteen frame periods comprises one to fourteen subsequent data pulses and for example corresponds with the pixel 11 displaying one of a limited number of gray values between full black and full white.

The reset data pulses R precede the driving data pulses Dr to further improve the optical response of the display unit 1, by defining a fixed starting point (fixed black or fixed white) for the driving data pulses Dr. Alternatively, reset data pulses R precede the driving data pulses Dr to further improve the optical response of the display unit, by defining a flexible starting point (black or white, to be selected in dependence of and closest to the gray value to be defined by the following driving data pulses) for the driving data pulses Dr.

In FIG. 4, a part of the display panel 50 is shown diagrammatically. This part comprises four pixels 11. A first pixel 11 is coupled via a transistor 12 to a row electrode 43 and to a column electrode 34. A second pixel 11 is coupled via a transistor 12 to the row electrode 43 and to a column electrode 35. A third pixel 11 is coupled via a transistor 12 to a row electrode 44 and to the column electrode 34. A fourth pixel 11 is coupled via a transistor 12 to the row electrode 44 and to the column electrode 35. The first and second pixel 11 are each coupled via a storage capacitor 13 to a storage line 62, and the third and fourth pixel 11 are each coupled via a storage capacitor 13 to a storage line 63. The storage lines 62 and 63 are coupled to a storage line driver 60. The pixels 11 are further coupled to the common electrode 22, which is coupled to a common electrode driver 25. These drivers 25 and 60 are further coupled to the controller 20. The storage capacitors 13 improve the stability of the signals on the pixels 11. Further, in addition, four parasitic capacitors 14 are disclosed. Each parasitic capacitor 14 represents the drain gate junction capacitor of a transistor 12.

In practice, the storage capacitor 13 is 10-100 times larger than the capacity of the pixel 11 and the parasitic capacitor 14. At the end of a frame, this parasitic capacitor 14 introduces a voltage jump on its pixel, which voltage jump is also known as a so-called kickback voltage. The kickback voltage swing is for example about 2.5 Volt for a gate voltage swing of about 25 Volt, and is for example about 5 Volt for a gate voltage swing of about 50 Volt. This can be derived from the relationship between the parasitic capacitor 14 on the one hand and the sum of the parasitic capacitor 14 and the storage capacitor 13 and the capacity of the pixel 11 on the other hand. The kickback voltage at the end of a frame results in an increased value of the gate de-activation voltage, and might result in display artifacts. In a prior art situation, for example the storage line driver 60 or for example the common electrode driver 25 is used to compensate for such display artifacts.

For polymer electronics active-matrix back planes with E-ink, the typical voltages are a row activation voltage of −25 V, a row de-activation voltage of +25 V, a column voltage between −15 V and +15 V and a common electrode voltage of 5 V. The row deactivation voltage is set 10 V higher than the maximum column voltage. This is because the highest pixel voltage is +15 V plus 5 V=+20 V. As the row de-activation voltage must be taken higher than this maximum pixel voltage +25 V is the lowest possible row de-activation voltage. Without the kickback voltage the row de-activation voltage could be reduced with 5 V. This would result in a row voltage swing that is 45 V instead of 50 V, which corresponds with −10%. So, by for example removing the kickback voltage, the row voltage swing can be reduced with 10%.

According to the invention, the storage line driver 60,70 is used for driving the storage line 62 in such a way that a necessary electrode voltage swing is reduced. This will be explained at the hand of FIGS. 7, 9, 10 and 13, in view of FIG. 6 which show a prior art row electrode signal Vg and a prior art column electrode signal Vc for a negative pixel electrode signal Vp (FIG. 6A) and for a positive pixel electrode signal Vp (FIG. 6B) in voltage (Volts) versus time (msec).

In FIG. 6A, during a first row activation pulse Vg=−25 V, a column voltage Vc=−15 V, and as a result a pixel electrode voltage Vp changes from Vp=0 V to Vp=−15 V. Then, a first row de-activation pulse Vg=+25 V is started, and as a result the pixel electrode voltage Vp jumps from −15 V to −10 V (kickback) and then slowly changes from −10 V to for example −8 V. During the first row de-activation pulse Vg=+25 V, the column voltage Vc=0 V. This has been done for the sake of simplicity, because other rows are activated during this row de-activation pulse, and the pixels in these other rows will need to be supplied with data via this same column electrode. During a second row activation pulse Vg=−25 V, a column voltage Vc=−15 V, and as a result a pixel electrode voltage Vp jumps from Vp=−8 V to Vp=−13 V and then changes from −13 V to −15 V. Then, a second row de-activation pulse Vg=+25 V is started etc.

In FIG. 6B, during a first row activation pulse Vg=−25 V, a column voltage Vc=+15 V, and as a result a pixel electrode voltage Vp changes from Vp=0 V to Vp=+15 V. Then, a first row de-activation pulse Vg=+25 V is started, and as a result the pixel electrode voltage Vp jumps from +15 V to +20 V (kickback) and then slowly changes from +20 V to for example +18 V. During the first row de-activation pulse Vg=+25 V, the column voltage Vc=0 V. This has been done for the sake of simplicity, because other rows are activated during this row de-activation pulse, and the pixels in these other rows will need to be supplied with data via this same column electrode. During a second row activation pulse Vg=−25 V, a column voltage Vc=+15 V, and as a result a pixel electrode voltage Vp jumps from +18 V to +13 V and then changes from Vp=+13 V to Vp=+15 V. Then, a second row de-activation pulse Vg=+25 V is started etc.

In FIGS. 6A and 6B, the pulses are shown as applied in a polymer electronics active-matrix back plane with p-type TFTs. For n-type TFTs (e.g. amorphous silicon) the polarity of the row pulses and the common electrode voltage are inverted. In FIG. 6A, the pixel is charged to −15 V (e.g. a white pixel). In FIG. 6B, the pixel is charged to +15 V (e.g. a black pixel). The effect of the kickback voltage is that all pixels are pulled to a different voltage level at the end of the line selection period. For p-type TFTs that are switched to their conductive state by lowering the row voltage, the kickback voltage is always positive, while for n-type TFTs it is negative. This can be compensated for by adjusting the common electrode voltage to the value of the kickback voltage, such as for example a constant voltage of 5 V. This is not shown in FIG. 6.

As can be derived from FIG. 6, the necessary (minimal) row electrode voltage swing or necessary (minimal) selection electrode voltage swing is about 50 V. This is relatively high and results in common available drivers not being usable and in a relatively high power consumption. By, according to the invention, letting the storage line driver 60 generate a storage line pulse (a first storage line signal according to the invention) during at least a part of the row activation pulse, this necessary (minimal) row electrode voltage swing can be reduced. This is disclosed in FIG. 7.

In FIG. 7A, during a first row activation pulse Vg=−25 V, a column voltage Vc=−15 V, a storage line pulse Vs=+5 V (the first storage line signal according to the invention), and as a result a pixel electrode voltage Vp changes from Vp=0 V to Vp=−15 V. Then, a first row de-activation pulse Vg=+20 V is started, and as a result the pixel electrode voltage Vp slowly changes from −15 V to for example −13 V. During the first row de-activation pulse Vg=+20 V, the column voltage Vc=0 V. This has been done for the sake of simplicity, because other rows are activated during this row de-activation pulse, and the pixels in these other rows will need to be supplied with data via this same column electrode. During a second row activation pulse Vg=−25 V, a column voltage Vc=−15 V, a storage line pulse Vs=+5 V, and as a result a pixel electrode voltage Vp changes from −13 V to −15 V. Then, a second row de-activation pulse Vg=+20 V is started etc.

In FIG. 7B, during a first row activation pulse Vg=−25 V, a column voltage Vc=+15 V, a storage line pulse Vs=+5 V (the first storage line signal according to the invention), and as a result a pixel electrode voltage Vp changes from Vp=0 V to Vp=+15 V. Then, a first row de-activation pulse Vg=+20 V is started, and as a result the pixel electrode voltage Vp slowly changes from +15 V to for example +13 V. During the first row de-activation pulse Vg=+20 V, the column voltage Vc=0 V. This has been done for the sake of simplicity, because other rows are activated during this row de-activation pulse, and the pixels in these other rows will need to be supplied with data via this same column electrode. During a second row activation pulse Vg=−25 V, a column voltage Vc=+15 V, a storage line pulse Vs=+5 V, and as a result a pixel electrode voltage Vp changes from Vp=+13 V to Vp=+15 V. Then, a second row de-activation pulse Vg=+20 V is started etc.

Clearly, the kickback jumps no longer are present, and as a result, the extreme positive value of the row de-activation pulse can be reduced from +25 V to +20 V. The necessary (minimal) row electrode voltage swing is then reduced from +50 V to +45 V, which allows the use of common available drivers and which reduces the power consumption.

An end of the row activation pulse should precede or should correspond with an end of the storage line pulse. To avoid the so-called kickback voltage, the end of the row activation pulse should preferably not exceed the end of the storage line pulse.

Because of the storage line pulse possibly to a large extent coinciding with the row activation pulse, the storage line driver 60 may be integrated into the row driver 40. An example is shown in FIG. 5.

In FIG. 5, a part of the display panel 50 is shown diagrammatically. This part corresponds with the part shown in FIG. 4, apart from the fact that the storage lines 62 and 63 are coupled to a row driver 70 or selection driver 70. This row driver 70 or selection driver 70 comprises a first stage 71 for driving the selection electrodes 42-44 and comprises a second stage 72 constituting the storage line driver 60 as disclosed in FIG. 4. In this efficient case, only one selection electrode driver with two output stages is used (for a predefined number of selection electrodes) for generating the activation pulse and the storage line pulse. Both these pulses may have large similarities. The first stage 71 for example comprises a row driver comprising a row output transistor per row, with the second stage 72 then comprising an other output transistor per storage line, of which other output transistor at least a control electrode is coupled to a control electrode of the output transistor.

FIG. 8 shows a reflectivity (in %) versus time (msec) for a conventional driving scheme without kickback compensation on the common electrode, for a conventional driving scheme with kickback compensation on the common electrode and for a driving scheme in accordance with FIG. 7. Clearly, the difference for the pixel between the conventional driving scheme with kickback compensation on the common electrode and a driving scheme in accordance with FIG. 7 is negligible.

According to the invention, it is alternatively possible to let the storage line driver 60 generate an other storage line pulse (a second storage line signal according to the invention) during at least a part of the row activation pulse, to reduce the necessary (minimal) row electrode voltage swing. This is disclosed in FIG. 9.

In FIG. 9A, during a first part of a first row activation pulse Vg=0 V, a column voltage Vc=+15 V, a storage line pulse Vs=+30 V (a first part of the second storage line signal according to the invention), and as a result a pixel electrode voltage Vp changes from Vp=+30 V to Vp=+15 V. During a second part of the first row activation pulse Vg=0 V, a column voltage Vc=−15 V, a storage line pulse Vs=0 V (a second part of the second storage line signal according to the invention), and as a result a pixel electrode voltage Vp jumps from Vp=+15 V to Vp=−15 V. Then, a first row de-activation pulse Vg=+25 V is started, and as a result the pixel electrode voltage Vp jumps from −15 V to for example −12 V and then slowly changes from −12 V to for example −10 V. During the first row de-activation pulse Vg=+25 V, the column voltage Vc=0 V. This has been done for the sake of simplicity, because other rows are activated during this row de-activation pulse, and the pixels in these other rows will need to be supplied with data via this same column electrode. During a first part of a second row activation pulse Vg=0 V, a column voltage Vc=+15 V, a storage line pulse Vs=+30 V, and as a result a pixel electrode voltage Vp jumps from −10 V to for example +17 V and then changes from +17 V to +15 V. During a second part of a second row activation pulse Vg=0 V, a column voltage Vc=−15 V, a storage line pulse Vs=0 V, and as a result a pixel electrode voltage Vp jumps from +15 V to −15 V. Then, a second row de-activation pulse Vg=+25 V is started etc.

In FIG. 9B, during a first part of a first row activation pulse Vg=0 V, a column voltage Vc=+15 V, a storage line pulse Vs=+30 V (a first part of the second storage line signal according to the invention), and as a result a pixel electrode voltage Vp changes from Vp=+30 V to Vp=+15 V. During a second part of the first row activation pulse Vg=0 V, a column voltage Vc=+15 V, a storage line pulse Vs=0 V (a second part of the second storage line signal according to the invention), and as a result a pixel electrode voltage Vp jumps from Vp=+15 V to Vp=−15 V and then changes from −15 V to +15 V. Then, a first row de-activation pulse Vg=+25 V is started, and as a result the pixel electrode voltage Vp jumps from +15 V to for example +18 V and then slowly changes from +18 V to for example +16 V. During the first row de-activation pulse Vg=+25 V, the column voltage Vc=0 V. This has been done for the sake of simplicity, because other rows are activated during this row de-activation pulse, and the pixels in these other rows will need to be supplied with data via this same column electrode. During a first part of a second row activation pulse Vg=0 V, a column voltage Vc=+15 V, a storage line pulse Vs=+30 V, and as a result a pixel electrode voltage Vp jumps from +16 V to for example +46 V and then changes from +46 V to +15 V. During a second part of a second row activation pulse Vg=0 V, a column voltage Vc=+15 V, a storage line pulse Vs=0 V, and as a result a pixel electrode voltage Vp jumps from +15 V to −15 V and then changes from −15 V to +15 V. Then, a second row de-activation pulse Vg=+25 V is started etc.

For both FIGS. 9A and 9B, it is assumed that the common electrode is driven with a constant voltage of for example +2 V or +3 V. Clearly, the extreme negative value of the row activation pulse can be reduced from −25 V to 0 V. The necessary (minimal) row electrode voltage swing is then reduced from +50 V to +25 V, which allows the use of common available drivers and which reduces the power consumption.

In this case, an end of the storage line pulse should preferably precede an end of the row activation pulse, to get the wanted result. The storage line driver 60 might again be integrated into the row driver 40, only this time the end of the storage line pulse and the end of the row activation pulse will preferably not coincide.

According to the invention, it is alternatively possible to let the storage line driver 60 generate an other storage line pulse (a third storage line signal according to the invention) during at least a part of the row activation pulse, to reduce the necessary (minimal) row electrode voltage swing. This is disclosed in FIG. 10.

In FIG. 10A, during a first part of a first row activation pulse Vg=−10 V, a column voltage Vc=0 V, a storage line pulse Vs=+15 V (a first part of the third storage line signal according to the invention), and as a result a pixel electrode voltage Vp changes from Vp=+15 V to Vp=0 V. During a second part of the first row activation pulse Vg=−10 V, a column voltage Vc=−15 V, a storage line pulse Vs=0 V (a second part of the third storage line signal according to the invention), and as a result a pixel electrode voltage Vp jumps from Vp=0 V to Vp=−15 V. Then, a first row de-activation pulse Vg=+25 V is started, and as a result the pixel electrode voltage Vp jumps from −15 V to for example −13 V and then slowly changes from −13 V to for example −11 V. During the first row de-activation pulse Vg=+25 V, the column voltage Vc=0 V. This has been done for the sake of simplicity, because other rows are activated during this row de-activation pulse, and the pixels in these other rows will need to be supplied with data via this same column electrode. During a first part of a second row activation pulse Vg=−10 V, a column voltage Vc=0 V, a storage line pulse Vs=+15 V, and as a result a pixel electrode voltage Vp jumps from −11 V to for example +3 V and then changes from +3 V to 0 V. During a second part of a second row activation pulse Vg=−10 V, a column voltage Vc=−15 V, a storage line pulse Vs=0 V, and as a result a pixel electrode voltage Vp jumps from 0 V to −15 V. Then, a second row de-activation pulse Vg=+25 V is started etc.

In FIG. 10B, during a first part of a first row activation pulse Vg=−10 V, a column voltage Vc=+15 V, a storage line pulse Vs=+15 V (a first part of the third storage line signal according to the invention), and as a result a pixel electrode voltage Vp changes from Vp=0 V to Vp=+15 V. During a second part of the first row activation pulse Vg=−10 V, a column voltage Vc=+15 V, a storage line pulse Vs=0 V (a second part of the third storage line signal according to the invention), and as a result a pixel electrode voltage Vp jumps from Vp=+15 V to Vp=0 V and then changes from 0 V to +15 V. Then, a first row de-activation pulse Vg=+25 V is started, and as a result the pixel electrode voltage Vp jumps from +15 V to for example +18 V and then slowly changes from +18 V to for example +16 V. During the first row de-activation pulse Vg=+25 V, the column voltage Vc=0 V. This has been done for the sake of simplicity, because other rows are activated during this row de-activation pulse, and the pixels in these other rows will need to be supplied with data via this same column electrode. During a first part of a second row activation pulse Vg=−10 V, a column voltage Vc=+15 V, a storage line pulse Vs=+15 V, and as a result a pixel electrode voltage Vp jumps from for example +16 V to for example +31 V and then changes from +31 V to +15 V. During a second part of a second row activation pulse Vg=−10 V, a column voltage Vc=+15 V, a storage line pulse Vs=0 V, and as a result a pixel electrode voltage Vp jumps from +15 V to 0 V and then changes from 0 V to +15 V. Then, a second row de-activation pulse Vg=+25 V is started etc.

For both FIGS. 10A and 10B, it is assumed that the common electrode is driven with a constant voltage of for example +2 V or +3 V. Clearly, the extreme negative value of the row activation pulse can be reduced from −25 V to −10 V. The necessary (minimal) row electrode voltage swing is then reduced from +50 V to +35 V, which allows the use of common available drivers and which reduces the power consumption.

In this case, an end of the storage line pulse should preferably precede an end of the row activation pulse, to get the wanted result. The storage line driver 60 might again be integrated into the row driver 40, only this time the end of the storage line pulse and the end of the row activation pulse will preferably not coincide.

FIG. 11 shows a reflectivity (in %) versus time (msec) for a conventional driving scheme and for a driving scheme in accordance with FIG. 9. Clearly, the difference for the pixel between being driven via a conventional driving scheme and a driving scheme in accordance with FIG. 9 is negligible.

FIG. 12 shows a reflectivity (in %) versus time (msec) for a conventional driving scheme and for a driving scheme in accordance with FIG. 10. Clearly, the difference for the pixel between being driven via a conventional driving scheme and a driving scheme in accordance with FIG. 10 is negligible.

According to the invention, it is alternatively possible to let the storage line driver 60 generate storage line alternating pulses (a fourth storage line signal according to the invention), to reduce the necessary (minimal) column electrode voltage swing. This is disclosed in FIG. 13.

In FIG. 13A, during a first part of a first row activation pulse Vg=−10 V, a column voltage Vc=0 V, a positive storage line alternating pulse Vs=+15 V (a first part of the fourth storage line signal according to the invention), and as a result a pixel electrode voltage Vp changes from Vp=+15 V to Vp=0 V. During a second part of the first row activation pulse Vg=−10 V, a column voltage Vc=−15 V, a negative storage line alternating pulse Vs=−15 V (a second part of the fourth storage line signal according to the invention), and as a result a pixel electrode voltage Vp changes from Vp=0 V to Vp=−30 V. Then, a first row de-activation pulse Vg=+40 V is started. Due to the storage line alternating pulses Vs going on, the pixel electrode voltage Vp keeps on jumping from 0 V to −30 V and back. During the first row de-activation pulse Vg=+40 V, the column voltage Vc=0 V. This has been done for the sake of simplicity, because other rows are activated during this row de-activation pulse, and the pixels in these other rows will need to be supplied with data via this same column electrode. During a first part of a second row activation pulse Vg=−10 V, a column voltage Vc=0 V, a positive storage line alternating pulse Vs=+15 V, and as a result a pixel electrode voltage Vp=0 V. During a second part of a second row activation pulse Vg=−10 V, a column voltage Vc=−15 V, a negative storage line alternating pulse Vs=−15 V, and as a result a pixel electrode voltage Vp=−30 V. Then, a second row de-activation pulse Vg=+40 V is started etc.

In FIG. 13B, during a first part of a first row activation pulse Vg=−10 V, a column voltage Vc=0 V, a positive storage line alternating pulse Vs=+15 V (a first part of the fourth storage line signal according to the invention), and as a result a pixel electrode voltage Vp changes from Vp=+15 V to Vp=0 V. During a second part of the first row activation pulse Vg=−10 V, a column voltage Vc=0 V, a negative storage line alternating pulse Vs=−15 V (a second part of the fourth storage line signal according to the invention), and as a result a pixel electrode voltage Vp jumps from 0 V to −30 V and then changes from Vp=−30 V to Vp=0 V. Then, a first row de-activation pulse Vg=+40 V is started. Due to the storage line alternating pulses Vs going on, the pixel electrode voltage Vp keeps on jumping from +30 V to 0 V and back. During the first row de-activation pulse Vg=+40 V, the column voltage Vc=0 V. This has been done for the sake of simplicity, because other rows are activated during this row de-activation pulse, and the pixels in these other rows will need to be supplied with data via this same column electrode. During a first part of a second row activation pulse Vg=−10 V, a column voltage Vc=0 V, a positive storage line alternating pulse Vs=+15 V, and as a result a pixel electrode voltage Vp changes from +30 V to 0 V. During a second part of a second row activation pulse Vg=−10 V, a column voltage Vc=0 V, a negative storage line alternating pulse Vs=−15 V, and as a result a pixel electrode voltage Vp jumps from 0 V to −30 V and then changes from −30 V to 0 V. Then, a second row de-activation pulse Vg=+40 V is started etc.

For both FIGS. 13A and 13B, clearly, the extreme positive value of the column activation pulse can be reduced from +15 V to 0 V. The necessary (minimal) column electrode voltage swing is then reduced from +30 V to +15 V, which allows the use of less expensive drivers and which reduces the power consumption. About the high-frequency voltages on the pixel Vp, the frequency of these voltages is that high that the pixel will not be able to follow each change. Instead of that, the pixel will follow the average value of these voltages.

The alternating pulses generated by the storage line driver 60 should have a period of at most a duration of a row activation pulse. Preferably, this period should be equal the duration of this row activation pulse, or half this duration, or one-third, one-fourth etc. of this duration.

To support the storage line driver 60 for supplying the alternating pulses via the storage capacitor to the pixel, a common electrode driver 25 may be used for supplying additional alternating pulses to the pixel 11 via the common electrode 22.

All storage lines 62,63 may be coupled to each other such that they are all driven in parallel. In this efficient case, one storage line driver 60 is used for supplying the alternating pulses to all storage lines 62,63 simultaneously.

For FIGS. 7, 9, 10 and 13, other amplitudes, other (pulse) durations, other (pulse) starting moments in time, other (pulse) ending moments in time, other and/or more storage line pulse parts (for example in FIG. 9 or 10) and/or other duty cycles may be used, without departing from the scope of this invention. Calculations prove the fact that the power consumption of the entire display unit is reduced, even when taking into account that in some cases the driving of the storage lines according to the invention may introduce a higher storage line power consumption. The increase of the higher storage line power consumption is always smaller than a reduction of the power consumption necessary for driving the row electrodes and/or the column electrodes. Further, the embodiments shown in the FIGS. 7, 9, 10 and 13 may be combined into more complex embodiments. The invention can be used for integrated and non-integrated drivers.

A first advantage is that with the proposed driving scheme the stability of the (integrated) drivers will be higher, as the drive voltages on the rows are up to 50% lower. A second advantage is that the display unit can be made smaller (smaller drivers, smaller TFTs), because of the lower drive voltages. A third advantage is that the power consumption of the display unit will be lower, as the power consumption is proportional to the drive voltages squared. The proposed drive scheme can be applied to all active-matrix displays. It is most suited for application in displays with integrated drivers. The proposed drive scheme can also be combined with other drive schemes for electrophoretic displays.

Controller 20 comprises and/or is coupled to a memory (not shown) like, for example, a look-up table memory for storing information about the waveforms. The invention is not limited to electrophoretic display panels but can be used for any display panel based on bi-stable pixels.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display unit (1) comprising:
a display panel (50) with a pixel (11) coupled to a storage line (62) via a storage capacitor (13); and
a storage line driver (60,70) for driving the storage line (62) for reducing a necessary electrode voltage swing.

2. A display unit (1) as claimed in claim 1, further comprising an electrode driver (30,40,70) for driving an electrode (31,32,34,35,39,41,42,43,44,45,49) coupled to the pixel (11) via a switching element (12), the electrode voltage swing being a voltage swing of this electrode (31,32,34,35,39,41,42,43,44,45,49).

3. A display unit (1) as claimed in claim 2, the electrode (41,42,43,44,45,49) being a selection electrode and the selection electrode driver (40,70) being arranged to generate an activation pulse for activating the selection electrode (41,42,43,44,45,49) and the storage line driver (60,70) being arranged to generate a storage line pulse during at least a part of the activation pulse.

4. A display unit (1) as claimed in claim 3, the electrode driver (40,70) being further arranged to generate a de-activation pulse for de-activating the selection electrode (41,42,43,44,45,49).

5. A display unit (1) as claimed in claim 4, the de-activation pulse having a reduced extreme value such that the necessary electrode voltage swing is reduced.

6. A display unit (1) as claimed in claim 3, the activation pulse having a reduced extreme value such that the necessary voltage swing is reduced.

7. A display unit (1) as claimed in claim 3, an end of the activation pulse preceding or corresponding with an end of the storage line pulse.

8. A display unit (1) as claimed in claim 3, the selection electrode driver (70) comprising a first stage (71) for driving the electrode (41,42,43,44,45,49) and a second stage (72) constituting the storage line driver (60).

9. A display unit (1) as claimed in claim 2, the electrode (31,32,34,35,39) being a data electrode and the data electrode driver (30) being arranged to generate a data pulse and the storage line driver (60) being arranged to generate alternating pulses having a period of at most a duration of an activation pulse, the display unit (1) further comprising
a selection electrode driver (40) for generating the activation pulse for activating a selection electrode (41,42,43,44,45,49).

10. A display unit (1) as claimed in claim 9, further comprising a common electrode driver (25) for driving a common electrode (22) with the alternating pulses.

11. A display unit (1) as claimed in claim 9, further comprising
the display panel (50) with a further pixel (11) coupled to a further storage line (63) via a further storage capacitor (13), which further storage line (63) is coupled to the storage line (62);
the storage line driver (60) being arranged to drive both storage lines (62,63) simultaneously.

12. A display unit (1) as claimed in claim 9, the data pulse having a reduced extreme value such that the necessary voltage swing is reduced.

13. A display unit (1) as claimed in claim 1, further comprising a controller (20), which is adapted to provide:
shaking data pulses (Sh₁,Sh₂);
one or more reset data pulses (R); and
one or more driving data pulses (Dr);
to the pixel (11).

14. A display device comprising a display unit (1) as claimed in claim 1 and further comprising a storage medium for storing information to be displayed.

15. A method for driving a display unit (1) comprising a display panel (50) with a pixel (11) coupled to a storage line (62) via a storage capacitor (13), the method comprising the step of driving the storage line (62) for reducing a necessary electrode voltage swing.

16. A processor program product for driving a display unit (1) comprising a display panel (50) with a pixel (11) coupled to a storage line (62) via a storage capacitor (13), the processor program product comprising the function of driving the storage line (62) for reducing a necessary electrode voltage swing.
